(19) United States
(12) Patent Application Publication
(10) Pub. No.: US 2012/0326627 A1
(43) Pub. Date: Dec. 27, 2012

(54) SYSTEMS AND METHODS FOR CONTROLLING WHITE LIGHT

(75) Inventor: Donald L. McDaniel, JR., North Andover, MA (US)

(73) Assignee: Luminus Devices, Inc., Billerica, MA (US)

(21) Appl. No.: 13/523,586

(22) Filed: Jun. 14, 2012

Related U.S. Application Data
(60) Provisional application No. 61/496,752, filed on Jun. 14, 2011.

(51) Int. Cl. H05B 37/02

(52) U.S. Cl. 315/294

(57) ABSTRACT

Systems and methods for controlling the emission of white light are generally described. In certain embodiments, the systems and method relate to controlling white light emitted from a plurality of light-emitting diodes.

### RELATED APPLICATIONS

This application claims priority under 35 U.S.C. §119(e) to U.S. Provisional Patent Application Ser. No. 61/496,752, filed Jun. 14, 2011 under attorney docket number L0655.70116US00, and entitled “A System and Method for Controlling White Light,” which is incorporated herein by reference in its entirety for all purposes.

### TECHNICAL FIELD

Systems and methods for controlling the emission of white light are generally described. In certain embodiments, the systems and methods relate to controlling white light emitted from a plurality of light-emitting diodes.

### BACKGROUND

Light-emitting diodes (LEDs) can generally provide light in a more efficient manner than incandescent and/or fluorescent light sources. Typically, an LED is formed of multiple layers, with at least some of the layers being formed of different materials. In general, the materials and thicknesses selected for the layers influence the wavelength(s) of light emitted by the LED. In addition, the chemical composition of the layers can be selected to promote isolation of injected electrical charge carriers into regions (e.g., quantum wells) for relatively efficient conversion to light. Generally, the layers on one side of the junction where a quantum well is grown are doped with donor atoms that result in high electron concentration (such layers are commonly referred to as n-type layers), and the layers on the opposite side are doped with acceptor atoms that result in a relatively high hole concentration (such layers are commonly referred to as p-type layers).

LEDs that emit white light are known in the art. For example, certain organic light-emitting diodes can be configured to emit white light. LEDs that emit non-white light can be configured to emit white light by depositing a wavelength-converting material such as a phosphor over the emission surface of the LED.

### SUMMARY

Systems and methods for controlling the emission of white light, for example, from light-emitting diodes, are generally described. The subject matter of the present invention involves, in some cases, interrelated products, alternative solutions to a particular problem, and/or a plurality of different uses of one or more systems and/or articles.

In one aspect, a light-emitting system is provided. The light-emitting system comprises, in certain embodiments, a first light-emitting diode configured to emit substantially white light having a first position on a CIE 1960 chromaticity diagram; a second light-emitting diode configured to emit substantially white light having a second position on the CIE 1960 chromaticity diagram, wherein the position of the light emitted from the second light-emitting diode is different from the position of the light emitted by the first light-emitting diode; and a third light-emitting diode configured to emit substantially white light having a third position on the CIE 1960 chromaticity diagram, wherein the position of the light emitted from the third light-emitting diode is different from the position of the light emitted by the first light-emitting diode and different from the position of the light emitted by the second light-emitting diode. In some embodiments, the system is configured such that the intensities of the first, second, and third light-emitting diodes can be adjusted, and the system is configured to produce cumulative emissions of substantially white light at at least three points on a black body locus of the CIE 1960 chromaticity diagram.

In one aspect, a method is provided. The method comprises, in some embodiments, emitting substantially white light from a first light-emitting diode of a light-emitting system, the substantially white light from the first light-emitting diode having a first position on a CIE 1960 chromaticity diagram; emitting substantially white light from a second light-emitting diode of the light-emitting system, the substantially white light from the second light-emitting diode having a second position on the CIE 1960 chromaticity diagram; and emitting substantially white light from a third light-emitting diode of the light-emitting system, the substantially white light from the third light-emitting diode having a third position on the CIE 1960 chromaticity diagram. In certain embodiments, the method comprises adjusting the intensity of light emitted from a first light-emitting diode, independently of the intensity of the light emitted from at least one of the second and third light-emitting diodes.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B are exemplary CIE 1960 chromaticity plots;

FIG. 2A is a top-view schematic diagram of an arrangement of three LEDs, according to one set of embodiments;

FIGS. 2B-2E are, according to certain embodiments, CIE 1960 chromaticity plots illustrating the CIE coordinates of light emitted from a plurality of LEDs;

FIG. 3A is, according to one set of embodiments, a top-view schematic diagram of an arrangement of four LEDs;

FIGS. 3B-3D are CIE 1960 chromaticity plots illustrating the CIE coordinates of light emitted from a plurality of LEDs, according to some embodiments;

FIG. 3E is an exemplary schematic diagram illustrating the operation of a light-emitting system;

FIGS. 4A-4B are top view schematic diagrams of arrays of LEDs, according to certain embodiments;

FIG. 5 is a schematic, perspective-view illustration of a light-emitting device die that can be used in association with certain embodiments;

FIG. 6A is a schematic flow diagram outlining a process for making an exemplary light-emitting system, according to some embodiments; and

FIG. 6B is an exemplary CIE 1931 chromaticity diagram including a plurality of bins of CIE coordinates, according to certain embodiments.

### DETAILED DESCRIPTION

Television and movie producers are often very particular about the color of white light they use when shooting film or recording. Chromaticity deviation toward the green side of the color spectrum is particularly objectionable. Within the lighting industry, a blackbody curve has been developed with correlating temperatures indicating the color of light. Generally, higher temperatures are referred to as cool white while lower temperatures are referred to as warm white. Unlike natural incandescent light, light with discontinuous spectra (like that produced by LED and fluorescent light sources) may be perceived differently by film, digital camera sensors, and the eye. As a result, the natural eye will perceive the light to be one color, but when the recorded film or video is replayed, the coloring will be off. Digital sensors can be calibrated (balanced) over a range of white points; however, if the light changes with the ambience or if natural light enters the area, the remainder will appear off.

It would be desirable to have a tunable white light that can be adjusted (e.g., manually or automatically) to produce white light of a desired correlated color temperature and/or offset from the black body locus. Accordingly, described herein are systems and methods for controlling the emission of substantially white light, including controlling the emission of substantially white light emitted from at least three light-emitting diodes. In some such embodiments, a plurality of light-emitting diodes (e.g., at least three light-emitting diodes) can emit substantially white light, and each light-emitting diode within the plurality of light-emitting diodes can have a different position relative to the black body locus on the CIE 1960 chromaticity diagram. The intensities of the lights emitted by the light-emitting diodes can be, in certain embodiments, adjusted. In certain embodiments, the intensities of the lights emitted by the light-emitting diodes can be independently adjusted. Independent adjustment of the intensities of the light emitted by the light-emitting diodes can allow one to produce a combined output of light with a variety of color temperatures. For example, one can adjust the relative intensities of the light emitted from the light-emitting diodes to produce a combined light output that lies on any of a variety of positions along the black body locus.

The intensities of the emissions from a first and a second LED are said to be independently adjustable when an adjustment in the first LED does not automatically produce the same adjustment in the second LED. For example, the intensity of a first LED can be independently adjustable from the intensity of a second LED when increasing the intensity of the light emitted from the first LED does not automatically increase the intensity of the second LED. In certain embodiments, the intensities of the first, second, and/or third LEDs can be completely decoupled. Adjustment of the intensity of a first LED is completely decoupled from the adjustment of the intensity of a second LED when changing the intensity of the first LED does not cause any change in the intensity of the second LED. Accordingly, in certain embodiments, an adjustment to one of the first, second, and/or third LEDs does not cause any change in intensity in either of the remaining two LEDs. An example of such systems is one in which separate knobs are used to control the intensities of first, second, and third LEDs.

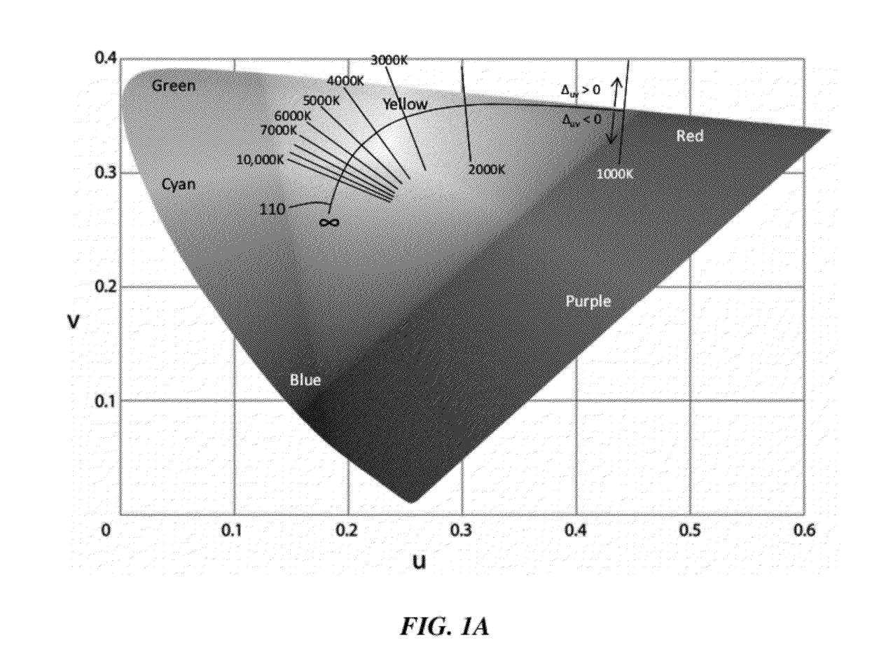

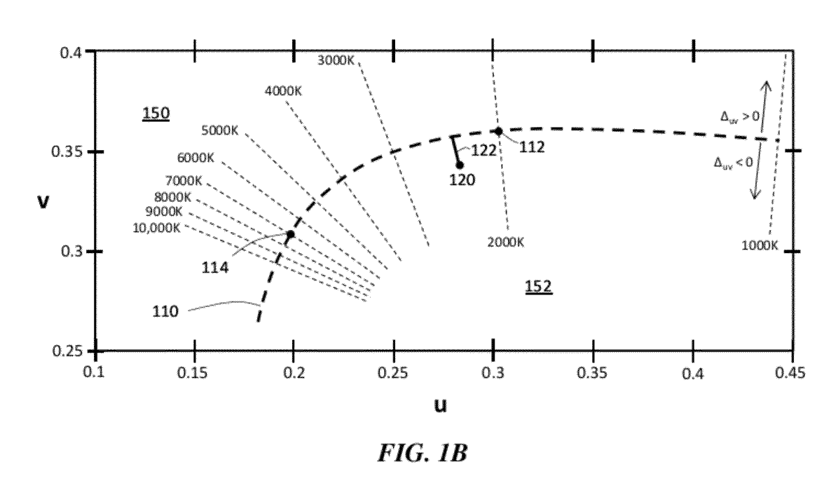

Those of ordinary skill in the art are familiar with the CIE 1960 chromaticity diagram. The CIE 1960 chromaticity diagram is a 2-dimensional plot of the mathematically-defined CIE 1960 color space, which was created by the International Commission on Illumination in 1960. FIG. 1A is an exemplary CIE chromaticity plot. In FIG. 1A, the x-axis (labeled “u”) corresponds to the u-coordinate of the CIE 1960 color space, and the y-axis (labeled “v”) corresponds to the v-coordinate of the CIE 1960 color space. For a given emission of light, the u- and v-coordinates can be determined, and the output can be plotted on the diagram in FIG. 1A. For example, lights with blue and violet tones generally reside on the lower half of the plot (i.e., they have relatively low v-coordinate values), deep green light generally lies in the upper left quadrant (i.e., having relatively high v-coordinate values and relatively low u-coordinate values), and red light generally lies in the upper-right part of the plot. The z-axis in CIE 1960 color space generally corresponds to the intensity of the light and is not plotted on the chromaticity diagram illustrated in FIG. 1A. One of ordinary skill in the art would be capable of determining the CIE 1960 coordinates of a given light output by, for example, measuring a spectrum of sufficient fidelity over the relevant wavelength range using a spectroradiometer, and applying known algebraic equations. Such methods are described, for example, in the document CIE 15-2004, which is incorporated herein by reference in its entirety for all purposes. Unless otherwise specified, the coordinates and color space references described herein refer to the CIE 1960 color space.

In certain embodiments, the combined output of the light-emitting devices can be used to produce a perceived color that lies on or near the black body locus. The black body locus is known to those of ordinary skill in the art, and refers to a curve (or locus) corresponding to the chromaticity of radiation emitted by an ideal black body emitter (i.e., an emitter that absorbs no radiation) over a range of ideal black body emitter temperatures. Such a curve can be constructed, for example, by measuring the spectra and computing the u- and v-coordinates in CIE 1960 color space of an ideal black body emitter over a range of temperatures, plotting the resulting points on the CIE 1960 chromaticity diagram, and constructing a curve that joins the points. More commonly, the spectra are computed using the well-known Planckian formula for the emitted spectrum of an ideal black body of a given temperature and subsequent calculations are performed against this spectrum. This concept is illustrated in FIG. 1B, which focuses on the area of the CIE 1960 chromaticity plot near the black body locus. In FIG. 1B, the black body locus is indicated by dotted line 110. The CIE coordinates of the light that would be output by the ideal black body emitter when at a temperature of 2000 Kelvin (about 1726.85° C.) are indicated at point 112 in FIG. 1B. The CIE coordinates of the light that would be output by the ideal black body emitter when at a temperature of 7000 Kelvin (about 6726.85° C.) are indicated at point 114 in FIG. 1B. The black body locus is also shown as curve 110 in FIG. 1A.

In certain embodiments, the intensities of at least one of (or all of) the LEDs can be varied such that the combined output of the light-emitting devices produces a desired correlated color temperature (CCT). The CCT of a given light output may be determined by plotting the chromaticity of the light output on a CIE 1960 chromaticity diagram and determining the corresponding point on the black body locus that is closest to the plotted point. The color temperature of the corresponding point on the black body locus is the CCT of the given light output. For example, in FIG. 1B, light with a chromaticity corresponding to point 120 would have a correlated color temperature of about 2400 Kelvin, which is determined by constructing line segment 122 that is perpendicular to black body locus 110 and that intersects point 120. The color temperature of the point at which line segment 122 intersects black body locus 110 is about 2400 Kelvin; accordingly, the correlated color temperature of point 120 is also 2400 Kelvin. Iso-CCT lines (i.e., lines along which all points have the same CCT value) are perpendicular to the black body locus in the CIE 1960 color space. FIGS. 1A-1B include iso-CCT lines for the color temperatures of 1000 Kelvin, 2000 Kelvin, 3000 Kelvin, 4000 Kelvin, 5000 Kelvin, 6000 Kelvin, 7000 Kelvin, 8000 Kelvin, 9000 Kelvin, and 10,000 Kelvin.

It is possible to use just two LEDs having different chromaticities to tune across a range of Correlated Color Temperatures (CCTs). However, tuning linearly using LEDs with two chromaticities allows one to vary the chromaticity of the combined light output over only a straight line, and cannot be used to match the curve of the black body locus (because the black body locus is non-linear). Hence, when only two LEDs are used to tune chromaticity, the chromaticity of the resultant combined light output can overlap with the black body locus over, at most, only two points. All other tuning points will deviate to one side of the black body locus or the other. Accordingly, at most points along such a line, the cumulative light output will appear to have a green cast (when the chromaticity lies above the black body locus) or a magenta cast (when the chromaticity lies below the black body locus).

It has been discovered, within the context of certain embodiments of the invention, that a larger assortment of chromaticities can be produced when at least three LEDs are used to produce a controlled output of white light, relative to the assortment of chromaticities that can be produced when only two LEDs are employed. In certain embodiments, at least three LEDs can be used to produce a controlled output of white light that follows the black body locus over a range of color temperatures.

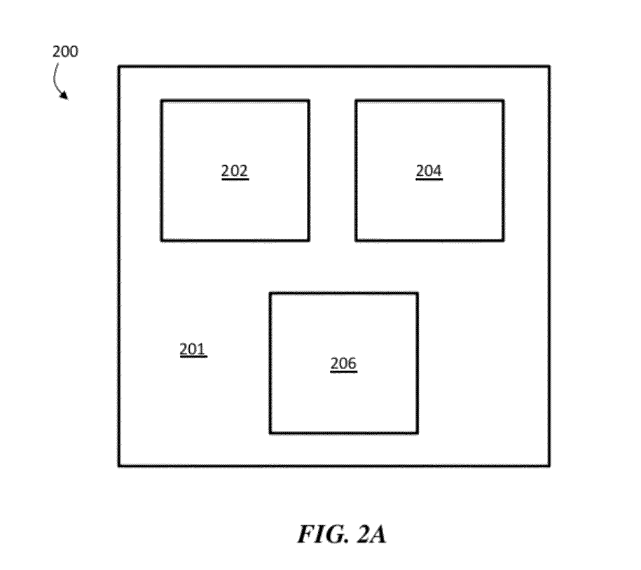

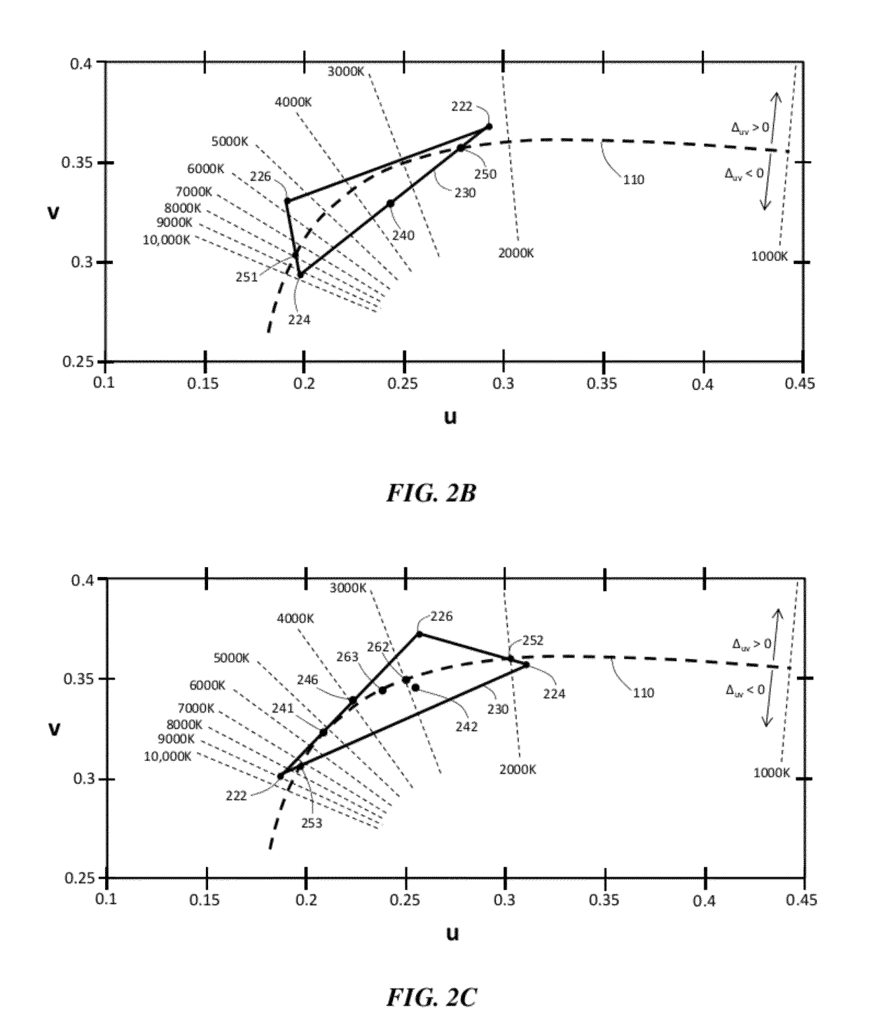

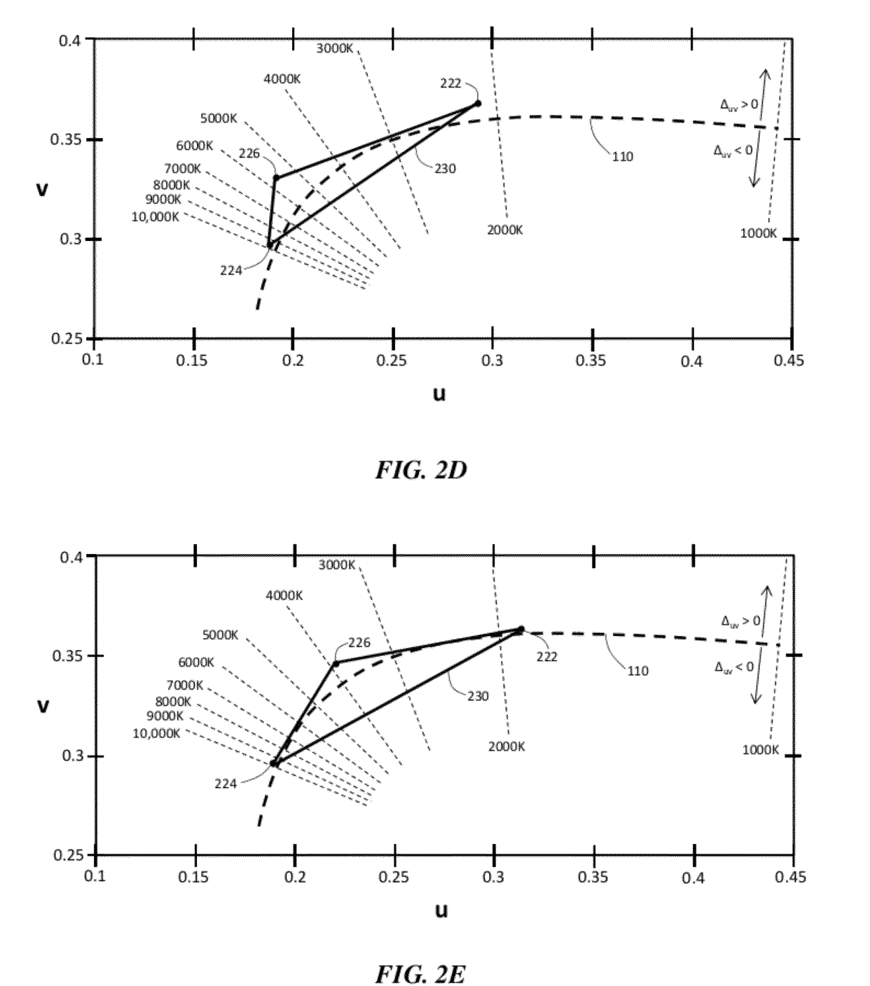

FIG. 2A is a top-view schematic illustration of a system 200 comprising LEDs 202, 204, and 206. LEDs 202, 204, and 206 can be mounted in certain embodiments, for example, on substrate 201, which can be a printed circuit board, a wafer, or any other suitable substrate. As described in more detail below, LEDs 202, 204, and 206 can each emit light having a different chromaticity, and can be configured such that their light outputs are mixed to produce a cumulative output of light having a chromaticity corresponding to the perceived chromaticity of the mixed light.

In some embodiments, each of LEDs 202, 204, and 206 is configured to emit substantially white light. The term substantially white light is generally used herein to refer to light having a chromaticity that, when plotted on the CIE 1960 chromaticity diagram, defines a Δᵤᵥ value having an absolute value of less than or equal to about 0.05. The Δᵤᵥ value of a given point on the CIE 1960 chromaticity diagram corresponds to the shortest distance between the point and the black body locus. The Δᵤᵥ value is also sometimes written as the “delta(uv)” value, and these two expressions are used interchangeably throughout this description. One of ordinary skill in the art would be familiar with the concept of the Δᵤᵥ value, which is illustrated with respect to point 120 in FIG. 1B. The Δᵤᵥ value of point 120 in FIG. 1B can be determined by drawing a line that is perpendicular to black body locus 110 and that intersects point 120, and measuring the length of the line segment 122 from black body locus 110 to point 120 (using the same dimensionless units as the u- and v-axes). In FIG. 1B, the Δᵤᵥ value of point 120 (i.e., the length of line segment 122) is about −0.02 (a negative value because point 120 is below black body locus 110), and the absolute value of the Δᵤᵥ value of point 120 is about 0.02. In certain embodiments, the LEDs used herein (e.g., LEDs 202, 204, 206, 302, 304, 306, 308, and/or additional LEDs within an array) can be configured to emit substantially white light with a Δᵤᵥ value having an absolute value of less than or equal to about 0.02, less than or equal to about 0.01, less than or equal to about 0.005, or less than or equal to about 0.002.

The use of LED structures that emit substantially white light (as opposed to LED structures that emit light that is relatively saturated in one color or another, such as LED structures that emit saturated blue light, red light, green light, or other colors) can be particularly advantageous, in certain embodiments. LED structures that emit saturated colors often have very narrow emission spectra. Accordingly, if such LEDs are used to produce a mixture of light that appears white, when such light is reflected, only the wavelengths within the narrow emission spectra are reflected, which can be undesirable in many lighting applications. When LEDs that emit substantially white light are used, on the other hand, the LED sources generally have wide emission spectra. When the light from the substantially white LED sources are mixed and reflected, a broader range of wavelengths are reflected, and the lighting appears to be more realistically white. Furthermore, the net efficacy of a combination of substantially white LEDs is significantly greater than that of a system of narrow spectrum colored LEDs.

In certain embodiments, light emitted from the LEDs is mixed to provide a cumulative output of light with a desired set of CIE coordinates and therefore a desired correlated color temperature. Output of a desired color temperature can be by achieved by selecting LEDs that emit light with different CIE coordinates. For example, returning to FIG. 2A, in some embodiments, first LED 202 can be configured to emit substantially white light having a first position on a CIE 1960 chromaticity diagram. In addition, second LED 204 can be configured to emit substantially white light having a second position on the CIE 1960 chromaticity diagram, wherein the position of the light emitted from LED 204 is different from the position of the light emitted by LED 202. Third LED 206 can be configured to emit substantially white light having a third position on the CIE 1960 chromaticity diagram, wherein the position of the light emitted from LED 206 is different from the position of the light emitted by LED 202 and different from the position of the light emitted by LED 204. It should be understood that the labeling of LEDs as “first,” “second,” and “third” are arbitrary, and that such convention is used to generally denote LEDs that emit light having different coordinates on the CIE 1960 chromaticity diagram. In addition, in certain embodiments, a plurality of LEDs of a given type (e.g., a plurality of LEDs 202, a plurality of LEDs 204, and/or a plurality of LEDs 206) can be used to achieve the effects described herein.

In some embodiments, the intensities of the light emitted from the LEDs can be independently adjusted, for example, to produce a desired color temperature. As one example, in a system comprising a first, second, and third LED, the LEDs can be independently adjustable when the intensity of the light emitted from the first LED can be adjusted (increased or decreased) without impacting the intensity of the light emitted from the second and third LEDs, the intensity of the light emitted from the second LED can be adjusted without impacting the intensity of the light emitted from the first and third LEDs, and the intensity of the light emitted from the third LED can be adjusted without impacting the intensity of the light emitted from the first and second LEDs.

Adjustment of the intensity of the light output by an LED can result in a change in the perceived brightness of the LED. Some LEDs are configured to emit a fixed intensity of light as a function of time. If an LED emits light at a fixed brightness over a period of time, the intensity of the light emitted from the LED can be adjusted by adjusting the constant intensity emitted by the LED. On the other hand, some LEDs can be configured to modulate the intensity of the light (e.g., sinusoidally, as a step-function change, or via any other type of modulation) emitted by the LED, often at high frequencies. As a specific example, some LEDs can be configured to output light with an intensity that oscillates (e.g., sinusoidally) at a set frequency. When light output is modulated with a frequency above 200 Hz, such modulations are usually perceived by the human eye as continuous. For video production, modulation frequencies are generally set higher than 200 Hz, and are often set based on the cameras that the source is intended to be used (and, in some such cases, LED intensities can be varied continuously by changing the drive current). In some embodiments in which the intensity of the LED is oscillated during operation, adjustment of the intensity of the LED can be achieved by adjusting (e.g., increasing and/or decreasing) the average intensity of the light emitted by the LED. In the case of sinusoidally-oscillating intensity, the average intensity corresponds to the mid-point between the crest and trough of the sinusoidal wave produced when the intensity is plotted as a function of time. One of ordinary skill in the art, given the present disclosure, would be capable of calculating the average intensity of the light emitted by an LED using, for example, a spectrophotometer. In some embodiments, adjustment of the intensity of the light emitted by an LED can comprise adjustment of the average intensity of light emitted by the LED. In some such embodiments, adjustment of the average intensity of light emitted by the LED comprises adjustment of the average intensity emitted by the LED over a fixed period of time (e.g., 1 second).

In certain embodiments, the intensity of the first, second, and/or third LED (and/or any additional LEDs) can be adjusted from a first non-zero intensity to a second non-zero intensity, such that the difference between the first and second average non-zero intensities is at least about 5%, at least about 10%, at least about 25%, or at least about 50% of the maximum average intensity that the LED is configured to emit.

In some embodiments, to produce a relatively warm cumulative light output (i.e., to produce light with a relatively high u-coordinate), one can adjust the intensity of the LEDs in the system such that the one or more warm LEDs within the plurality of LEDs are relatively bright. To produce a relatively cool cumulative light output (i.e., to produce light with a relatively low u-coordinate), one can adjust the intensity of the LEDs in the system such that the one or more cool LEDs within the plurality of LEDs are relatively bright. (It should be noted that, as described above, light outputs with higher, and thus more blue, color temperatures are counterintuitively referred to as cool, even though the temperature of the black body emitter that emits such light is relatively hot. In addition, light outputs with lower, and thus more yellow, color temperatures are counterintuitively referred to as warm, even though the temperature of the black body emitter that emits such light is relatively cold.) Similar strategies can be employed to produce relatively green cumulative light output (e.g., by adjusting the intensities of the LEDs in the system such that the LEDs with relatively large v-coordinates are relatively bright) and relatively pink cumulative light outputs (e.g., by adjusting the intensities of the LEDs in the system such that the LEDs with relatively large v-coordinates are relatively bright).

The ability to tailor the CIE coordinates of the cumulative light output by the plurality of LEDs is enhanced when LEDs that output light with widely-varying CIE coordinates are employed. For example, in certain embodiments, one LED (or subset of LEDs) may emit relatively cool substantially white light while another may emit relatively warm substantially white light. In some such embodiments, one can adjust the temperature of the cumulative light output by the system simply by adjusting the intensities of the two LEDs. To output the warmest light achievable in such systems, one can adjust the intensities of the LEDs in the system such that only the warm LED(s) emits light. To output the coolest light achievable in such systems, one can adjust the intensities of the LEDs such that only the cool LED(s) emits light. To output light with an intermediate temperature, one can adjust the intensities of the LEDs such that both warm and cool LEDs emit light, with the warm LEDs emitting light at higher intensity to produce a relatively warm cumulative light output, and the cool LEDs emitting light at a higher intensity to produce a relatively cool cumulative light output.

FIG. 2B is a CIE 1960 chromaticity diagram that illustrates the arrangement of one exemplary system in which three LEDs (or subsets of LEDs) are configured to produce a cumulative light output with a variety of CIE coordinates, correlated color temperatures, and/or Δᵤᵥ values. In FIG. 2B, first LED 202 is configured to emit substantially white light having first position 222 on the CIE 1960 chromaticity diagram. While position 222 is illustrated as being above black body locus 110 in FIG. 2B, in other embodiments, position 222 could be located on or below black body locus 110. In addition, in this set of embodiments, second LED 204 is configured to emit light having a second position 224 below black body locus 110. Third LED 206, in this set of embodiments, is configured to emit substantially white light having a third position 226 above black body locus 110. Generally, a position on a CIE chromaticity diagram is below the black body locus when the v-coordinate of the position has a value smaller than the v-coordinate of the point on the black body locus with the same u-coordinate. Such positions are said to have negative Δᵤᵥ values. A position on a CIE chromaticity diagram is above the black body locus when the v-coordinate of the position has a value larger than the v-coordinate of the point on the black body locus with the same u-coordinate. Such positions are said to have positive Δᵤᵥ values. In FIG. 1B, for example, all points within space 150 are above the black body locus, while all points within space 152 are below the black body locus.

In some embodiments, at least two of the LEDs within the plurality of LEDs can be spaced at least about 0.025, at least about 0.05, at least about 0.1, at least about 0.15, or at least about 0.2 CIE units away from each other when their CIE coordinates are plotted on the CIE 1960 chromaticity diagram. For example, in FIG. 2B, points 222 and 224 are about 0.125 units away from each other (which is calculated as the length of the line segment joining points 222 and 224).

In some embodiments, at least two of the LEDs can have correlated color temperatures that are relatively far apart. In certain embodiments, a first LED and a second LED in the system have correlated color temperatures that are at least about 500 Kelvin, at least about 1000 Kelvin, at least about 2000 Kelvin, at least about 3000 Kelvin, at least about 4000 Kelvin, at least about 5000 Kelvin, at least about 7500 Kelvin, or at least about 10,000 Kelvin apart. For example, in FIG. 2B, points 222 and 224 have correlated color temperatures that are about 7100 Kelvin apart.

In certain embodiments, the first LED can be configured to emit relatively warm substantially white light, for example, having a correlated color temperature of less than about 5000 K, less than about 4000 K, less than about 3000 K, or less than about 2000 K. For example, in FIG. 2B, LED 202 (emitting light with a chromaticity corresponding to point 222) is configured to emit light having a correlated color temperature of about 2100 K. In certain embodiments, the first LED can be configured to emit light having a chromaticity with a u-coordinate on the CIE chromaticity diagram of greater than about 0.225, greater than about 0.250, greater than about 0.275, greater than about 0.300, between about 0.225 and about 0.400, between about 0.225 and about 0.375, between about 0.250 and about 0.400, between about 0.250 and about 0.375, between about 0.275 and about 0.400, or between about 0.275 and about 0.375. For example, in FIG. 2B, LED 202 is configured to emit light having a u-coordinate on the CIE 1960 chromaticity diagram of about 0.295. In some such embodiments, the second and/or third LED can be configured to emit relatively cool substantially white light, for example, having a correlated color temperature of at least about 5000 K, at least about 6000 K, at least about 7000 K, at least about 8000 K, or at least about 9000 K. For example, in FIG. 2B, LED 204 (emitting light with a chromaticity corresponding to point 224) is configured to emit light having a correlated color temperature of about 9200 K, and LED 206 (emitting light with a chromaticity corresponding to point 226) is configured to emit light having a correlated color temperature of about 5800 K. In certain such embodiments, the second and/or third LED can be configured to emit light having a chromaticity with a u-coordinate on the CIE chromaticity diagram of less than about 0.225, less than about 0.200, less than about 0.175, between about 0.150 and about 0.225, between about 0.175 and about 0.225, between about 0.150 and about 0.200, or between about 0.175 and about 0.200. For example, in FIG. 2B, second LED 204 is configured to emit substantially white light having a u-coordinate of about 0.200, and third LED 206 is configured to emit substantially white light having a u-coordinate of about 0.195.

In FIG. 2B, second LED 204 (with a light output corresponding to point 224) and third LED 206 (with a light output corresponding to point 226) are configured to emit relatively cool light, while first LED 202 (with a light output corresponding to point 222) is configured to emit relatively warm light. In other embodiments, such as the set of embodiments illustrated in FIG. 2C, second LED 204 and third LED 206 are configured to emit relatively warm light, while first LED 222 is configured to emit relatively cool light. In some embodiments, the first LED can be configured to emit substantially white light having a correlated color temperature of at least about 5000 K, at least about 6000 K, at least about 7000 K, or at least about 8000 K. For example, in FIG. 2C, LED 202 (which is configured to emit light having a chromaticity corresponding to point 222) is configured to emit light having a color temperature of about 9000 K. The first LED can be configured to emit light with a chromaticity having a u-coordinate on the CIE chromaticity diagram of less than about 0.225, less than about 0.200, less than about 0.175, between about 0.150 and about 0.225, between about 0.175 and about 0.225, between about 0.150 and about 0.200, or between about 0.175 and about 0.200. For example, in FIG. 2C, LED 202 is configured to emit light having a u-coordinate on the CIE 1960 chromaticity diagram of about 0.19. In some such embodiments, the second and/or third LED can be configured to emit substantially white light having a correlated color temperature of less than about 5000 K, less than about 4000 K, less than about 3000 K, or less than about 2000 K. For example, in FIG. 2C, LED 204 (emitting light with a chromaticity corresponding to point 224) is configured to emit light having a correlated color temperature of about 1950 K, and LED 206 (emitting light with a chromaticity corresponding to point 226) is configured to emit light having a correlated color temperature of about 2800 K. In certain such embodiments, the second and/or third LED can be configured to emit light having a chromaticity with a u-coordinate on the CIE chromaticity diagram of greater than about 0.225, greater than about 0.250, greater than about 0.275, greater than about 0.300, between about 0.225 and about 0.400, between about 0.225 and about 0.375, between about 0.250 and about 0.400, between about 0.250 and about 0.375, between about 0.275 and about 0.400, or between about 0.275 and about 0.375. For example, in FIG. 2C, second LED 204 is configured to emit substantially white light having a u-coordinate of about 0.31, and third LED 206 is configured to emit substantially white light having a u-coordinate of about 0.26.

By independently controlling the relative intensities of LEDs 202, 204, and 206, the system can produce a cumulative light output having CIE coordinates residing anywhere within or on the boundaries of triangle 230 (which joins points 222, 224, and 226). The boundaries of triangle 230 are referred to herein as cumulative emission boundaries. For example, in FIG. 2B, point 240 lies on the line joining points 222 and 224, about equidistant from points 222 and 224. To produce a cumulative light output having CIE coordinates residing on point 240, the intensity of LED 206 (which emits light residing at point 226 on the CIE 1960 chromaticity diagram) can be reduced to 0, and the intensities of LED 202 (which emits light residing on point 222) and LED 204 (which emits light residing on point 224) can be set such that they are about equal. In FIG. 2C, point 241 lies on the line joining points 222 and 226, and is about twice as far away from point 226 as it is from point 222. To produce a cumulative light output having CIE coordinates residing on point 241, the intensity of LED 204 can be reduced to 0, and the intensity of LED 202 can be set such that it is about twice the intensity of LED 206. In FIG. 2C, point 242 lies in the geometric center of triangle 230. To produce cumulative light output having CIE coordinates residing on point 242, the intensities of LEDs 202, 204, and 206 can be set to equal values.

In certain embodiments, the system is configured to produce cumulative emissions of substantially white light at at least three points (or at at least four points, at least five points, at least ten points, or more) on the black body locus. In some embodiments, the system can be capable of producing cumulative emissions of substantially white light at an infinite number of points along the black body locus. For example, in the sets of embodiments illustrated in FIG. 2B, emissions from LEDs 202, 204, and 206 can be combined to produce cumulative emissions that lie anywhere along the curve segment of black body locus 110 joining points 251 and 250, which represents an infinite number of points. Similarly, in FIG. 2C, emissions from LEDs 202, 204, and 206 can be combined to produce cumulative emissions that lie anywhere along the curve segment of black body locus 110 joining points 252 and 253.

While the set of embodiments illustrated in FIGS. 2B and 2C include an LED that emits light with CIE coordinates below black body locus 110, the ability to produce cumulative emissions of substantially white light at at least three separate points on a black body locus can also be attained using three LEDs that each emit light with CIE coordinates above black body locus 110. FIGS. 2D-2E are schematic illustrations of two such systems, in which points 222, 224, and 226 are each located above black body locus 110. Due to the concave down curvature of black body locus 110, it is possible to produce cumulative outputs of light that lie below the black body locus, even though none of the LEDs in the system individually emit light with CIE coordinates that lie below black body locus 110. While systems that include only LEDs emitting light with CIE coordinates above the black body locus can be used in the systems described herein, it should be understood that it is often simpler to create a dynamic range of cumulative light outputs along the black body locus when LEDs with outputs both above and below the black body locus are used.

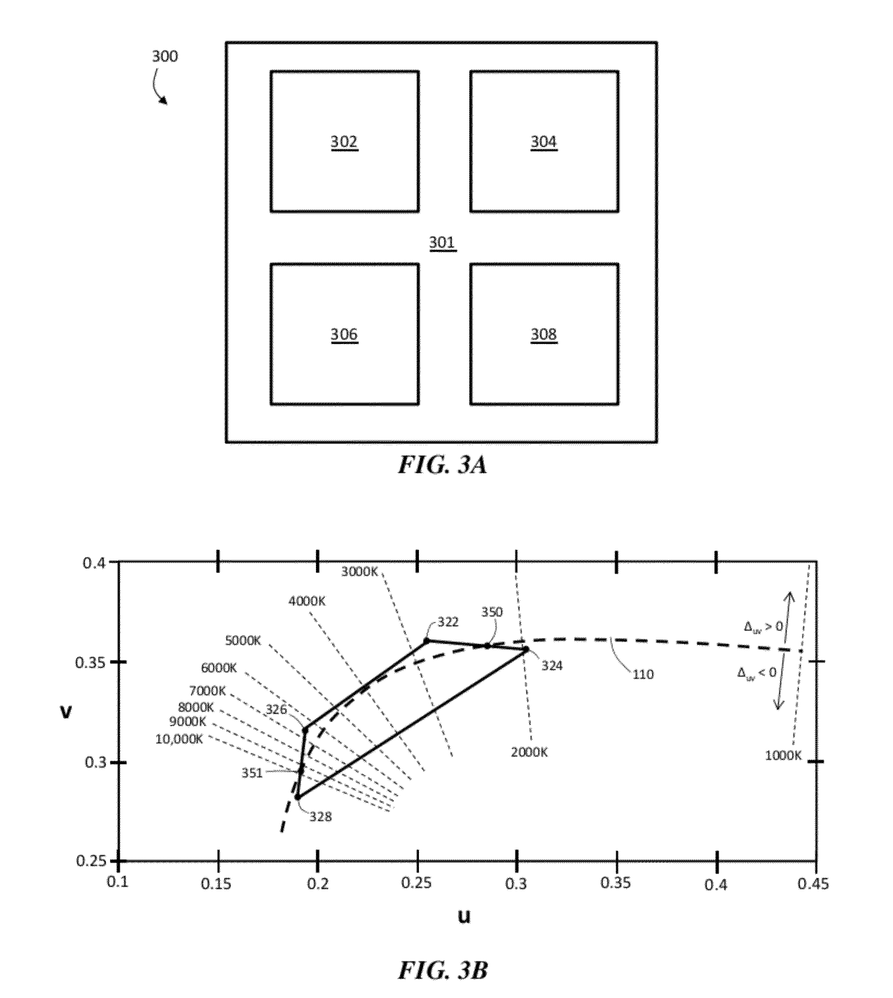

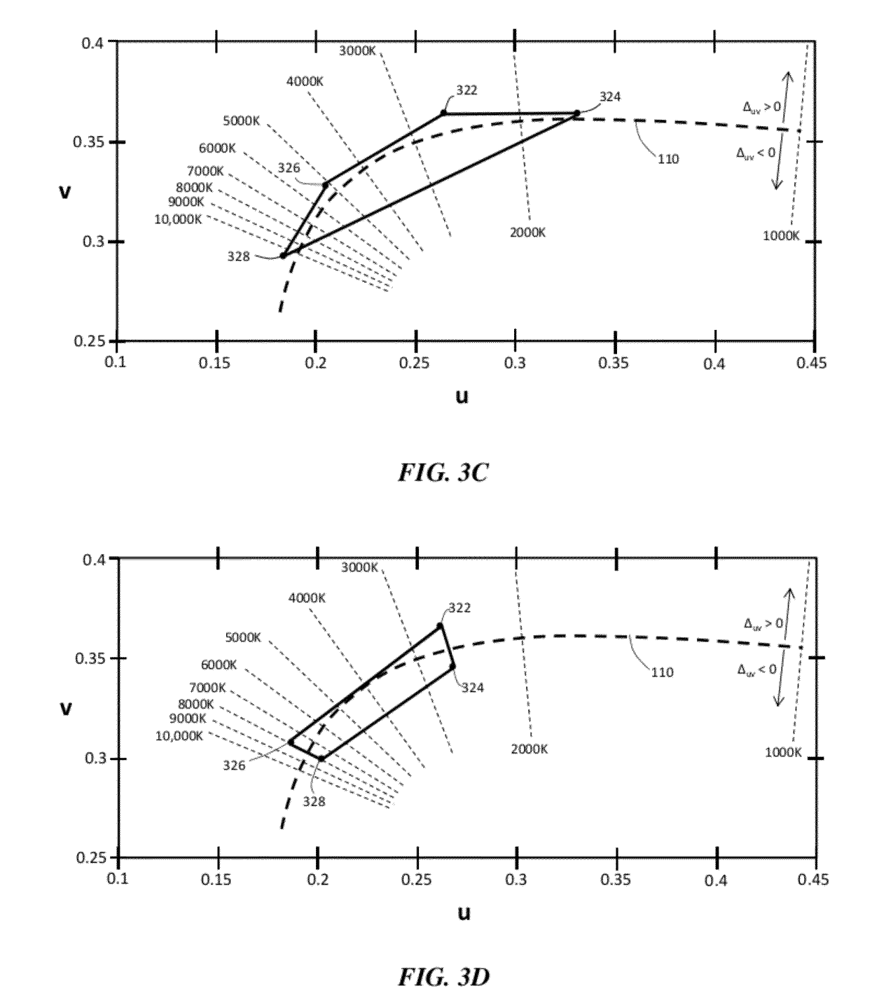

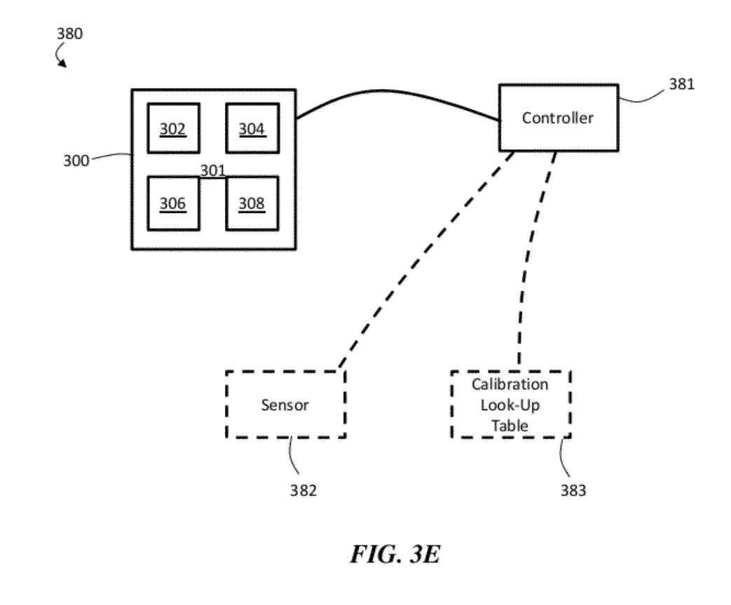

In some embodiments, more than three LEDs (or more than three types of LEDs) can be used in the system. For example, in certain embodiments, a fourth LED configured to emit substantially white light having a fourth position on the CIE 1960 chromaticity diagram that is different from the third position of the light emitted by the third light-emitting diode, different from the second position of the light emitted by the second light-emitting diode, and different from the first position of the light emitted by the first light-emitting diode can be employed. FIG. 3A is a top-view schematic illustration of system 300 comprising LEDs 302, 304, 306, and 308. LEDs 302, 304, 306, and 308 can be mounted in certain embodiments. For example, the LEDs can be mounted on substrate 301, which can be a printed circuit board, a wafer, or any other suitable substrate.

In certain embodiments, each of LEDs 302, 304, 306, and 308 is configured to emit substantially white light, with each LED emitting light with a different position within the CIE 1960 chromaticity diagram. FIG. 3B is a CIE 1960 chromaticity diagram that illustrates the arrangement of one exemplary system in which four LEDs (or subsets of LEDs) are configured to produce a cumulative light output with a variety of CIE coordinates (including a variety of correlated color temperatures). In FIG. 3B, first LED 302 is configured to emit substantially white light having first position 322 on the CIE 1960 chromaticity diagram. In addition, in this set of embodiments, second LED 304 is configured to emit substantially white light having a second position 324 below black body locus 110. Third LED 306 is, in this set of embodiments, configured to emit substantially white light having a third position 326 above black body locus 110. Also, in this set of embodiments, fourth LED 308 is configured to emit substantially white light having a fourth position 328 below black body locus 110.

In certain embodiments (e.g., those in which four LEDs are employed), the first and/or second LEDs can be configured to emit relatively warm substantially white light, for example, having a correlated color temperature of less than about 5000 K, less than about 4000 K, less than about 3000 K, or less than about 2000 K. For example, in FIG. 3B, LED 302 is configured to emit light having a correlated color temperature of about 2900 K and LED 304 is configured to emit light having a correlated color temperature of about 2000 K. In certain such embodiments, the first and/or second LEDs can be configured to emit light having a chromaticity with a u-coordinate on the CIE chromaticity diagram of greater than about 0.225, greater than about 0.250, greater than about 0.275, greater than about 0.300, between about 0.225 and about 0.400, between about 0.225 and about 0.375, between about 0.250 and about 0.400, between about 0.250 and about 0.375, between about 0.275 and about 0.400, or between about 0.275 and about 0.375. For example, in FIG. 3B, LED 302 is configured to emit light having a u-coordinate on the CIE 1960 chromaticity diagram of about 0.26 and LED 304 is configured to emit light having a u-coordinate of about 0.305. In some such embodiments, the third and/or fourth LED can be configured to emit relatively cool substantially white light, for example, having a correlated color temperature of at least about 5000 K, at least about 6000 K, at least about 7000 K, or at least about 8000 K. For example, in FIG. 3B, LED 306 is configured to emit light having a correlated color temperature of about 6500 K and LED 308 is configured to emit light having a correlated color temperature of about 12,000 K. In certain such embodiments, the third and/or fourth LEDs can be configured to emit light with a chromaticity having a u-coordinate on the CIE chromaticity diagram of less than about 0.225, less than about 0.200, less than about 0.175, between about 0.150 and about 0.225, between about 0.175 and about 0.225, between about 0.150 and about 0.200, or between about 0.175 and about 0.200. For example, in FIG. 3B, third LED 306 is configured to emit substantially white light having a u-coordinate of about 0.195, and fourth LED 308 is configured to emit substantially white light having a u-coordinate of about 0.190.

While the set of embodiments illustrated in FIG. 3B includes two LEDs that emit light with CIE coordinates below black body locus 110, the ability to produce three or more distinct cumulative emissions of substantially white light along the black body locus can also be attained using four LEDs that each emit light with CIE coordinates above black body locus 100. FIG. 3C is a schematic illustration of one such system in which points 322, 324, 326, and 328 are each located above black body locus 110. As described above, due to the concave down curvature of black body locus 110, it is possible to produce cumulative outputs of light that lie below the black body locus, even though none of the four LEDs in the system individually emit light with CIE coordinates that lie below black body locus 110. As noted above, while systems that include only LEDs emitting light with CIE coordinates above the black body locus can be used in the systems described herein, it is often simpler to create a dynamic range of cumulative light outputs along the black body locus when LEDs with outputs both above and below the black body locus are used.

In certain embodiments, the LEDs in the system can be selected or otherwise configured such that they can be adjusted (e.g., independently adjusted or otherwise) to produce cumulative emissions of light that reside along a relatively large portion of the black body locus. For example, in FIG. 2B, LEDs 202, 204, and 206 are configured such that the system is capable of producing cumulative light outputs with CIE coordinates lying along the black body locus from any color temperature between about 2500 Kelvin (e.g., at point 250) to about 8000 Kelvin (e.g., at point 251). In FIG. 2C, LEDs 202, 204, and 206 are configured such that the system is capable of producing a cumulative light output with CIE coordinates lying along the black body locus from any color temperature between about 2000 Kelvin (e.g., at point 252) to about 7200 Kelvin (e.g., at point 253). In FIG. 3B, LEDs 302, 304, 306, and 308 are configured such that the system is capable of producing a cumulative light output with CIE coordinates lying along the black body locus from any color temperature between about 2300 Kelvin (e.g., at point 350) to about 10,000 Kelvin (e.g., at point 351). In certain embodiments, the LEDs in the system can be configured such that the system is capable of producing cumulative light outputs along the black body locus with a range of color temperatures that spans at least about 500 Kelvin, at least about 1000 Kelvin, at least about 1500 Kelvin, at least about 2000 Kelvin, at least about 2500 Kelvin, at least about 3000 Kelvin, at least about 3500 Kelvin, at least about 4000 Kelvin, or at least about 5000 Kelvin. For example, the system illustrated in FIG. 2B is capable of producing cumulative light outputs along the black body locus with a range that spans 5500 Kelvin (i.e., the range of color temperatures along black body locus 110 from point 250 to 251). The system illustrated in FIG. 2C is capable of producing cumulative light outputs along the black body locus with a range that spans 5200 Kelvin (i.e., the range of color temperatures along black body locus 110 from point 252 to 253). In certain embodiments, the system is configured to produce a range of cumulative emissions of light such that the range includes all points along the black body locus within the range of between about 3000 Kelvin and about 3500 Kelvin (i.e., the range of cumulative emissions the system is capable of producing includes all points along black body locus 110 between point 262 and 263 in FIG. 2C), between about 3000 Kelvin and about 4000 Kelvin, between about 3000 Kelvin and about 4500 Kelvin, between about 3000 Kelvin and about 5000 Kelvin, between about 3000 Kelvin and about 5500 Kelvin, between about 3000 Kelvin and about 6000 Kelvin, between about 3000 Kelvin and about 7000 Kelvin, between about 3000 Kelvin and about 8000 Kelvin, between about 2700 Kelvin and about 3500 Kelvin, between about 2700 Kelvin and about 4000 Kelvin, between about 2700 Kelvin and about 4500 Kelvin, between about 2700 Kelvin and about 5000 Kelvin, between about 2700 Kelvin and about 5500 Kelvin, between about 2700 Kelvin and about 6000 Kelvin, between about 2700 Kelvin and about 7000 Kelvin, or between about 2700 Kelvin and about 8000 Kelvin.

In certain embodiments, the system can include four LEDs positioned such that the first and second LEDs have the same, first correlated color temperature and the third and fourth LEDs have the same, second correlated color temperature different from the first correlated color temperature. In some such embodiments, the first LED has a positive Δᵤᵥ value, and the second LED as a negative Δᵤᵥ value, wherein the absolute values of the Δᵤᵥ values of the first and second LEDs are the same. That is to say, in some such embodiments, the first and second LEDs lie on opposite sides of the black body locus and are spaced apart from the black body locus by equal distances. In some such embodiments, the third LED has a positive Δᵤᵥ value, and the fourth LED has a negative Δᵤᵥ value, wherein the absolute values of the Δᵤᵥ values of the third and fourth LEDs are the same. That is to say, in some such embodiments, the third and fourth LEDs lie on opposite sides of the black body locus and are spaced apart from the black body locus by equal distances. In some such embodiments, the absolute values of the Δᵤᵥ values of each of the first, second, third, and fourth LEDs are substantially the same. In certain embodiments, the first and second LEDs have correlated color temperatures that are at least about 500 Kelvin, at least 1000 Kelvin, at least 2000 Kelvin, at least 3000 Kelvin, at least 4000 Kelvin, or at least 5000 Kelvin different than the correlated color temperatures of the third and fourth LEDs.

FIG. 3D is a schematic illustration of one such system. In FIG. 3D, a first LED is configured to emit light having a chromaticity corresponding to point 322, and a second LED is configured to emit light having a chromaticity corresponding to point 324. Points 322 and 324 lie on an iso-CCT line, and accordingly, have the same correlated color temperature (of about 2700 Kelvin). In addition, the absolute values of the Δᵤᵥ values of points 322 and 324 are each about 0.02 (with point 322 having a Δᵤᵥ of +0.02 and point 324 having a Δᵤᵥ of −0.02). In FIG. 3D, a third LED is configured to emit light having a chromaticity corresponding to point 326, and a fourth LED is configured to emit light having a chromaticity corresponding to point 328. Points 326 and 328 also lie on an iso-CCT line, and accordingly, have the same correlated color temperature (of about 8000 Kelvin). In addition, the absolute values of the Δᵤᵥ values of points 326 and 328 are each about 0.02 (with point 326 having a Δᵤᵥ of +0.02 and point 328 having a Δᵤᵥ of −0.02).

Using LEDs configured to emit light with chromaticities spaced in the manner outlined in FIG. 3D can be advantageous. In certain such systems, the correlated color temperature of the cumulative light output by the system can be tuned by adjusting the following ratio:

$$\frac{{I}_{A} + {I}_{B}}{{I}_{C} + {I}_{D}} \qquad [ 1 ]$$

wherein I_{A} is the intensity of the first LED (e.g., emitting light with a chromaticity corresponding to point 322 in FIG. 3D), I_{B} is the intensity of the second LED (e.g., emitting light with a chromaticity corresponding to point 324 in FIG. 3D), I_{C} is the intensity of the third LED (e.g., emitting light with a chromaticity corresponding to point 326 in FIG. 3D), and I_{D} is the intensity of the fourth LED (e.g., emitting light with a chromaticity corresponding to point 326 in FIG. 3D). In addition, in certain such systems, the Δᵤᵥ of the cumulative light output by the system can be tuned by adjusting the following ratio:

$$\frac{{I}_{A} + {I}_{C}}{{I}_{B} + {I}_{D}} \qquad [ 2 ]$$

Such systems can be relatively easy to tune manually. When the LEDs are arranged as shown, for example, in FIG. 3D, ratios [1] and [2] are locally orthogonal such that adjustments to ratio [1] change only the correlated color temperature of the cumulative light output by the system and adjustments to ratio [2] change only the Δᵤᵥ value of the cumulative light output by the system. Thus, CCT and Δᵤᵥ variables can be tuned directly. This can eliminate the need to tune four LEDs individually, which is generally beneficial because tuning four LEDs individually is generally less intuitive for a person performing manual tuning. Due to the shape of the black body locus, there may be slight crosstalk at correlated color temperatures toward the middle of the controllable array of chromaticities (i.e., away from the end points near points 322, 324, 326, and 328 in FIG. 3D), but the system remains largely an orthogonal tuning system, which is quite intuitive.

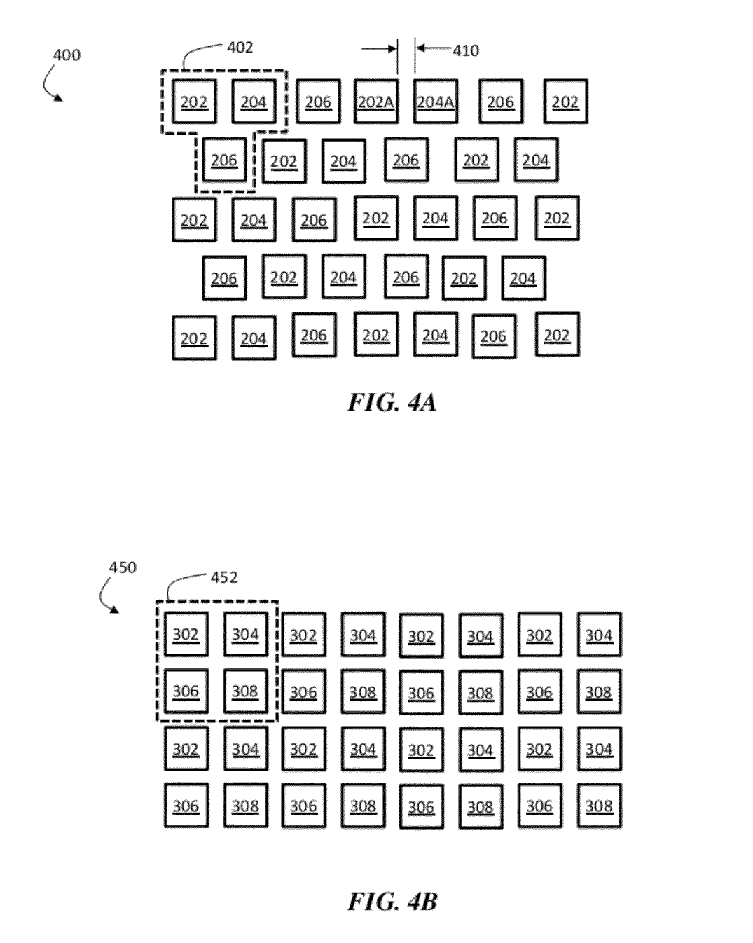

The LEDs described herein can be physically positioned in any suitable fashion. In certain embodiments, the first, second, and third LEDs (and/or any additional LEDs present in the system) can be arranged to form an array. For example, FIG. 2A illustrates a set of embodiments in which three LEDs (202, 204, and 206) are arranged in an array. In addition, FIG. 3A illustrates a set of embodiments in which four LEDs (302, 304, 306, and 308) are arranged in an array. In certain embodiments, LED types can be arranged in an array with a regularly-repeating unit cell. For example, FIG. 4A is a top-view schematic illustration of a system 400 in which LED types 202, 204, and 206 are arranged in a regularly-repeating array comprising unit cells 402. In FIG. 4B, system 450 comprises LED types 302, 304, 306, and 308, which are arranged in a regularly-repeating array comprising unit cells 452.

The LEDs within an array can be spaced any suitable distance apart from each other. In certain embodiments, the LEDs are spaced relatively close together. For example, in certain embodiments, the largest nearest neighbor distance between the first light-emitting diode, the second light-emitting diode, and the third light-emitting diode is less than about 10 cm, less than about 10 mm, less than about 1 mm, less than about 500 micrometers, or less than about 100 micrometers. The nearest neighbor distance between a first LED and a second LED refers to the shortest distance between the edges of the first LED and the edges of the second LED. For example, in FIG. 4A, the nearest neighbor distance between LED 202A and 204A corresponds to dimension 410.

While embodiments in which three and four LEDs (or three and four types of LEDs) have been illustrated, it should be understood that, in other embodiments, five, six, seven, eight, or more LEDs (or types of LEDs) can be used to produce the cumulative light outputs described herein.

As discussed above, the systems described herein can be used to produce light with a desired position on the CIE 1960 chromaticity diagram by adjusting (e.g., independently adjusting or otherwise) the intensity of the lights emitted from first, second, and third (and/or more) LEDs within the system. Such systems can be used, for example, as follows. A light-emitting system comprising first, second, and third LEDs can be provided. Light can be emitted from the first LED of a light-emitting system. The first LED can be configured to emit substantially white light having a first position on a CIE 1960 chromaticity diagram. Light can also be emitted from a second LED of the light-emitting system. The second LED can be configured to emit substantially white light having a second position on the CIE 1960 chromaticity diagram that is different than the first position of the light emitted by the first LED. In addition, light can be emitted from a third LED of the light-emitting system. The third LED can be configured to emit substantially white light having a third position on the CIE 1960 chromaticity diagram that is different from the first position of the light emitted by the first LED and the second position of the light emitted by the second LED. As one example, the first, second, and third LEDs can be configured to emit light having positions on the CIE 1960 chromaticity diagram corresponding to points 222, 224, and 226 on any of FIGS. 2B-2E.

In certain embodiments, the light output by the first light-emitting diode, the second light-emitting diode, and the third light-emitting diode can be mixed to form a cumulative light output by the system. This can be achieved, for example, by spacing the LEDs sufficiently close together such that the emission of each individual LED is no longer separately distinguishable (e.g., by a sensor or by the human eye). In certain embodiments, mixing of the light emitted by the LEDs can be enhanced by using one or more optical elements, such as lenses, waveguides, and other devices known to those of ordinary skill in the art.

In some embodiments, the intensity of the first LED is adjusted independently of the intensity of the light emitted from the second LED and, in certain embodiments, the third LED. In certain embodiments, the intensity of the second LED is adjusted independently of the intensity of the first LED and, in some embodiments, the third LED. In addition, the intensity of the third LED can be adjusted, in certain embodiments, independent of the intensity of the first LED and, in some instances, the second LED.

The ability to adjust (e.g., independently adjust) the intensities of the light emitted from the LEDs can allow one to tailor the CIE coordinates of the cumulative light output by the system. For example, one can adjust the intensities of the LEDs to alter the system such that it transitions from a first state in which it produces a cumulative light output residing on a first point on the chromaticity diagram to a second state in which it produces a cumulative light output residing on a second point on the chromaticity diagram. As one specific example, referring back to FIG. 2C, one can adjust the relative intensities of the light output by LEDs 202, 204, and 206 to move from one point on the CIE 1960 chromaticity diagram to another point on the CIE 1960 chromaticity diagram (e.g., to move from point 242 to point 241). One could adjust the intensity of LED 204 (which itself emits light having coordinates corresponding to point 224) from a first state in which it emits light at about the same intensity as LEDs 202 and 206 to a second state in which it emits substantially no light, which would result in the cumulative emission of light with CIE coordinates located around point 246 on the CIE chromaticity diagram in FIG. 2C. To move to point 241, one could adjust the intensities of LEDs 202 and 206 such that they transition from a first state in which they emit equal intensities of light to a second state in which LED 202 emits light that is about twice as intense as the light emitted from LED 206 (e.g., by adjusting the intensity of LED 202 upward and/or by adjusting the intensity of LED 206 downward).

Adjusting the relative intensities of the LEDs (or LED types) can allow one to adjust the cumulative emission of light from any first point on or within the cumulative emission boundaries of triangle 230 to any second point on or within the cumulative emission boundaries of triangle 230. In certain embodiments, adjusting the intensity of the light emitted from one or more of the LEDs (e.g., the first, second, and or third LEDs) results in a cumulative output of light from the light-emitting system that lies substantially on the black body locus on the CIE 1960 chromaticity diagram. As one example, in FIG. 2C, one can move from point 242 to point 262 by increasing the intensity of light output by LEDs 202 and 206 and/or by decreasing the intensity of light emitted by LED 204. In addition, the relative intensities of LEDs 202, 204, and 206 can be adjusted to produce a cumulative light output that resides anywhere along black body locus 110 in FIG. 2C between points 252 and 253.

The relative intensities of the light emitted from the LEDs can be controlled in any suitable fashion. In certain embodiments, the intensities of the light emitted from the LEDs can be manually controlled. For example, in some embodiments, the system can be configured such that turning a knob or adjusting a sliding switch adjusts the amount of current and/or voltage supplied to the LEDs, which in turn adjusts the intensities of the lights emitted by the LEDs.

In some embodiments, the light-emitting system comprises a controller configured to adjust the intensity of one or more LEDs within the system. As one example, the controller can comprise a general purpose processor that is programmed to refer to a lookup table (e.g., stored in memory) such that the controller automatically adjusts the relative intensities of the LEDs within the system to produce a desired cumulative light output. In some embodiments, the controller can implement a tuning algorithm to dial in a specified color temperature.

The controller within the light-emitting system can be configured, in some embodiments, such that the intensity of light emitted from one or more of the LEDs (e.g., the first, second, and/or third LEDs) is based at least in part on the wavelength and/or intensity of light in the ambient environment. For example, in some embodiments, a sensor can be used to determine at least one wavelength and/or intensity (optionally determining the CIE coordinates) of light present in the ambient environment. In response to receiving information regarding the wavelength and/or intensity of the light within the ambient environment, the controller can adjust the intensity of the light output by one or more of the LEDs of the system to produce an overall ambient light profile (which includes a mixture of the light present in the ambient environment as well as the light emitted by the light emitting system) with a desired position on the CIE chromaticity diagram (optionally, on the black body locus of the chromaticity diagram). In some such embodiments, the system can include one or more feedback controllers to produce the desired overall ambient light profile.

FIG. 3E is a schematic illustration of system 380, which can be used to perform one or more of the methods described herein. System 380 includes LED array 300. While an LED array including four LEDs is illustrated in FIG. 3E, it should be understood that, in other embodiments, an LED array comprising three, five, six, or more LEDs could be used and operated using the same principles described herein. In FIG. 3E, LED array 300 is configured to emit cumulative outputs of substantially white light at multiple points along the black body locus. Controller 381 can be configured to adjust the output levels of each individual LED chip to create a cumulative light output having a desired correlated color temperature and/or Δᵤᵥ from the black body locus. In certain embodiments, optional sensor 282 can either be manually or automatically implemented in system 380, for example, in a feedback control loop, which can help in dialing in a cumulative emission of light having desired CIE coordinates (i.e., a desired correlated color temperature and/or Δᵤᵥ). In certain embodiments, an optional calibration look up table 383 can be provided, which can allow controller 381 to adjust the relative outputs of LEDs 302, 304, 306, and 308 without the use of a complex algorithm to control the cumulative output of light.

The CIE coordinates of the light emitted by each of the LEDs within the light-emitting system can be controlled using a variety of suitable methods. For example, one of ordinary skill in the art would be capable of controlling the color of light emitted by a light-emitting device by selecting appropriate materials of construction. For example, LEDs emitting white light can be manufactured by homoepitaxially growing zinc selenide (ZnSe) on a ZnSe substrate, which results in the simultaneous emission of blue light from an active region and yellow light from the substrate. In addition, organic light emitting diodes that emit white light are known in the art.

The emission of substantially white light from LEDs that emit non-white light can also be achieved using wavelength-converting materials, such as phosphors and quantum dots. The wavelength-converting materials can convert emitted light of a first wavelength (e.g., light generated by the light-generation region of the LED) to light of a second, different wavelength. Accordingly, in certain embodiments, at least one of the first, second, and third (and/or additional) LEDs comprises a wavelength-converting material positioned over the emission surface of the LED. A variety of materials can be used as wavelength-converting materials in the embodiments described herein. In certain embodiments, the wavelength-converting material can comprise at least one quantum dot. In some preferred embodiments, the wavelength-converting material includes at least one phosphor material. The phosphor material can be present, for example, in particulate form. The phosphor particles may be distributed in a second material (e.g., an encapsulant or adhesive, such as epoxy) to form a composite structure.

In embodiments in which wavelength-converting materials are employed, the CIE coordinates of the light that is emitted from the LED can be adjusted by controlling the thickness of the wavelength converting material layer deposited on the light-emitting device. For example, for certain phosphor materials, thicker phosphor coatings produce cooler emitted light while thinner phosphor coatings produce warmer emitted light. The thickness of a phosphor or other wavelength-converting material can be controlled, for example, by controlling the thickness of the layer that is initially deposited on the emission surface of the LED and/or by etching back the thickness of the wavelength-converting material layer once it has been deposited.

The CIE coordinates of the light emitted from the LED can also be adjusted by controlling the types of wavelength-converting materials that are used within the wavelength-converting material layer. For example, white-emitting phosphors can be used, in certain embodiments. In other embodiments, combinations of phosphor materials (e.g., combinations of yellow-, red-, green-, or blue-emitting phosphors, and/or phosphors that emit other colors) can be used that together produce an emission of substantially white light. Any suitable phosphor material may be used as a wavelength-converting material. In some embodiments, the phosphor material may be a yellow phosphor material (e.g., (Y,Gd)(Al,Ga)G:Ce³⁺, sometimes referred to as a “YAG” (yttrium, aluminum, garnet) phosphor), a red phosphor material (e.g., L₂O₂S:Eu³⁺), a green phosphor material (e.g., ZnS:Cu,Al,Mn), and/or a blue phosphor material (e.g., (Sr,Ca,Ba,Mg)₁₀(PO₄)₆Cl:Eu²⁺). Other phosphor materials are also possible. Suitable phosphor materials have been described, for example, in U.S. Pat. No. 7,196,354, filed Sep. 29, 2005, entitled “Wavelength-converting Light-emitting Devices,” by Erchak, et al., which is incorporated herein by reference in its entirety.

In some embodiments, the average particle size of the wavelength-converting powder may be less than 100 micrometers. In some embodiments, the average particle size is less than 30 micrometers. In some embodiments, the average particle size of the wavelength-converting material powder may be between about 1 and 10 micrometers, between about 4 and 16 micrometers, between about 10 and 30 micrometers, or between about 30 and 100 micrometers. It should be understood that particle size ranges other than those described herein may also be used.

In addition, the ratio of wavelength-converting material to binder may vary. For example, the ratio of wavelength-converting material to binder may be at least about 0.1 g/mL, at least 0.5 g/mL, at least 1 g/mL, at least 2 g/mL, or higher. Good uniformity and thickness can be obtained using spin-coating processes that are well-known for use with other materials. Dense films may be obtained as shown by SEM images showing that the wavelength-converting material particles are densely packed. Pre-baked S—O-G can serve as a strong binding material. In some embodiments, wafers can undergo quick dump rinsing, spin rinse drying, and/or laser dicing without substantial wavelength-converting material loss.

In some embodiments, more than one layer of wavelength-converting material may be deposited (e.g., multiple layers of the same color, multiple layers each with a unique color, etc.). When multiple layers are present, the layer(s) may have one or more different type of wavelength-converting material than the other layer(s).

It should be noted that additional phosphor materials may be added, in some embodiments, during post-processing packaging. For example, in the case of a device which requires one or more phosphors, minor tuning with a single phosphor may be performed at the package level. In the case of a device which requires multiple phosphors (e.g. a majority of yellow phosphor with a small quantity of a red phosphor to improve the color rendering index of the final device) one phosphor (e.g., the yellow phosphor) could be applied at the wafer level and the other phosphor (e.g., the red phosphor) could be applied in small quantity at the package level. Similarly, additional materials may be added, in some embodiments, on top of the coating at the wafer level, according to the “multi-layer” approach described in the preceding paragraph.

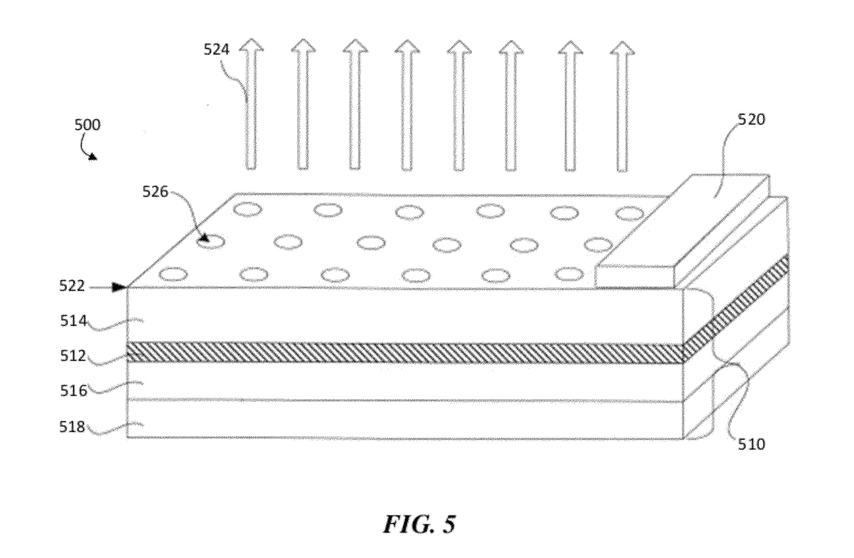

Any suitable type of LED can be used in the systems described herein, for example, as LEDs 202, 204, 206, 302, 304, 306, and/or 308 in FIGS. 2A and 3A. FIG. 5 is a perspective view schematic illustration of an exemplary LED 500 that may be used in connection with the embodiments described above. It should be understood that various embodiments presented herein can also be applied to other light-emitting dies, such as laser diode dies, and LED dies having different structures (such as organic LEDs, also referred to as OLEDs).

LED die 500 shown in FIG. 5 comprises a multi-layer stack 510 that may be disposed on a support structure (not shown), such as a submount (e.g., a metal submount). The multi-layer stack 510 can include an active region 512, which can be configured to generate light within the light-emitting diode. Active region 512 can be formed between n-doped layer(s) 514 and p-doped layer(s) 516. The stack can also include an electrically conductive layer 518 which may serve as a p-side contact and/or as an optically reflective layer. An n-side contact pad 520 may be disposed on layer 514. Electrically conductive fingers (not shown) and/or a current spreading layer (e.g., transparent conductive layer, such as a transparent conductive oxide) may extend from the contact pad 520 and along light emission surface 522, thereby allowing for uniform current injection into the LED structure.

It should be appreciated that the LED is not limited to the configuration shown in FIG. 5. For example, the n-doped and p-doped sides may be interchanged so as to form a LED having a p-doped region in contact with contact pad 520 and an n-doped region in contact with layer 518.

As described further below, electrical potential may be applied to the contact pads which can result in light generation within active region 512 and emission (represented by arrows 524) of at least some of the light generated through light emission surface 522. In certain embodiments, as described above, a wavelength-converting material (not shown for purposes of clarity) can be positioned over n-doped layer(s) 514 such that at least a portion of the light generated within active region 512 is absorbed by the wavelength-converting material and converted into light comprising wavelengths different from those generated within active region 512. In some such embodiments, active region 512 can be configured to generate non-white light, and the wavelength-converting material can be configured to produce substantially white light from the non-white light.

As described further below, holes 526 may be defined in an emission surface to form a pattern that can influence light emission characteristics, such as light extraction and/or light collimation. It should be understood that other modifications can be made to the representative LED structure presented, and that embodiments are not limited in this respect.

The active region of an LED can include one or more quantum wells (e.g., arranged as layers) surrounded by barrier layers. The quantum well structure may be defined by a semiconductor material layer (e.g., in a single quantum well), or more than one semiconductor material layers (e.g., in multiple quantum wells), with a smaller electronic band gap as compared to the barrier layers. Suitable semiconductor material layers for the quantum well structures can include InGaN, AlGaN, GaN and combinations of these layers (e.g., alternating InGaN/GaN layers, where a GaN layer serves as a barrier layer). In general, LEDs can include an active region comprising one or more semiconductors materials, including III-V semiconductors (e.g., GaAs, AlGaAs, AlGaP, GaP, GaAsP, InGaAs, InAs, InP, GaN, InGaN, InGaAlP, AlGaN, as well as combinations and alloys thereof), II-VI semiconductors (e.g., ZnSe, CdSe, ZnCdSe, ZnTe, ZnTeSe, ZnS, ZnSSe, as well as combinations and alloys thereof), and/or other semiconductors. Other light-emitting materials are possible such as quantum dots or organic light-emission layers.

The n-doped layer(s) 514 can include a silicon-doped GaN layer (e.g., having a thickness of about 4000 nm thick) and/or the p-doped layer(s) 516 can include a magnesium-doped GaN layer (e.g., having a thickness of about 40 nm thick). The electrically conductive layer 518 may be a reflective layer, such as a silver-containing layer (e.g., having a thickness of about 100 nm), which may reflects upwards any downward propagating light generated by the active region 512. Furthermore, although not shown, other layers may also be included in the LED; for example, an AlGaN layer may be disposed between the active region 512 and the p-doped layer(s) 516. It should be understood that compositions other than those described herein may also be suitable for the layers of the LED.

In some embodiments, a layer of the LED may have a dielectric function that varies spatially according to a pattern. For example, in FIG. 5, as a result of holes 526, LED 500 has a dielectric function across emission surface 522 that varies spatially according to a pattern. Typical hole sizes can be less than about one micron (e.g., less than about 750 nm, less than about 500 nm, less than about 250 nm). Typical nearest neighbor distances between holes can be less than about one micron (e.g., less than about 750 nm, less than about 500 nm, less than about 250 nm). Furthermore, as illustrated in FIG. 5, holes 526 can be non-concentric.

The dielectric function that varies spatially according to a pattern can influence the extraction efficiency and/or collimation of light emitted by the LED. In the illustrative LED die of FIG. 5, the pattern is formed of holes, but it should be appreciated that the variation of the dielectric function at an interface need not necessarily result from holes. Any suitable way of producing a variation in dielectric function according to a pattern may be used. The pattern may be periodic (e.g., having a simple repeat cell, or having a complex repeat super-cell), or non-periodic. As referred to herein, a complex periodic pattern is a pattern that has more than one feature in each unit cell that repeats in a periodic fashion. Examples of complex periodic patterns include honeycomb patterns, honeycomb base patterns, (2×2) base patterns, ring patterns, and Archimedean patterns. In some embodiments, a complex periodic pattern can have certain holes with one diameter and other holes with a smaller diameter. As referred to herein, a non-periodic pattern is a pattern that has no translational symmetry over a unit cell that has a length that is at least 50 times the peak wavelength of light generated by one or more light-generating portions. As used herein, peak wavelength refers to the wavelength having a maximum light intensity, for example, as measured using a spectroradiometer. Examples of non-periodic patterns include aperiodic patterns, quasi-crystalline patterns (e.g., quasi-crystal patterns having 8-fold symmetry), Robinson patterns, and Amman patterns. A non-periodic pattern can also include a detuned pattern (as described in U.S. Pat. No. 6,831,302 by Erchak, et al., which is incorporated herein by reference in its entirety). In some embodiments, the LED may include a roughened surface. In some cases, the LED may include a surface that is roughened but not patterned. In certain embodiments, an interface of a light-emitting diode is patterned with holes which can form a photonic lattice. Suitable LEDs having a dielectric function that varies spatially (e.g., a photonic lattice) have been described in, for example, U.S. Pat. No. 6,831,302, entitled “Light emitting devices with improved extraction efficiency,” filed on Nov. 26, 2003, which is herein incorporated by reference in its entirety. A high extraction efficiency for an LED implies a high power of the emitted light and hence high brightness which may be desirable in various optical systems.

Light may be generated by the LED as follows. The p-side contact layer can be held at a positive potential relative to the n-side contact pad, which causes electrical current to be injected into the LED. As the electrical current passes through the active region, electrons from n-doped layer(s) can combine in the active region with holes from p-doped layer(s), which can cause the active region to generate light. The active region can contain a multitude of point dipole radiation sources that generate light with a spectrum of wavelengths characteristic of the material from which the active region is formed. For InGaN/GaN quantum wells, the spectrum of wavelengths of light generated by the light-generating region can have a peak wavelength of about 445 nanometers (nm) and a full width at half maximum (FWHM) of about 30 nm, which is perceived by human eyes as blue light. The light emitted by the LED may be influenced by any patterned surface through which light passes, whereby the pattern can be arranged so as to influence light extraction and/or collimation.

In other embodiments, the active region can generate light having a peak wavelength corresponding to ultraviolet light (e.g., having a peak wavelength of about 370-390 nm), violet light (e.g., having a peak wavelength of about 390-430 nm), blue light (e.g., having a peak wavelength of about 430-480 nm), cyan light (e.g., having a peak wavelength of about 480-500 nm), green light (e.g., having a peak wavelength of about 500 to 550 nm), yellow-green (e.g., having a peak wavelength of about 550-575 nm), yellow light (e.g., having a peak wavelength of about 575-595 nm), amber light (e.g., having a peak wavelength of about 595-605 nm), orange light (e.g., having a peak wavelength of about 605-620 nm), red light (e.g., having a peak wavelength of about 620-700 nm), and/or infrared light (e.g., having a peak wavelength of about 700-1200 nm). In some such embodiments, wavelength-converting materials can be used to convert the wavelengths generated by the LED into substantially white light, as described above.

In certain embodiments, the LED may emit light having a high light output power. As described above, the high power of emitted light may be a result of a pattern that influences the light extraction efficiency of the LED. For example, the light emitted by the LED may have a total power greater than 0.5 Watts (e.g., greater than 1 Watt, greater than 5 Watts, or greater than 10 Watts). In some embodiments, the light generated has a total power of less than 100 Watts, though this should not be construed as a limitation of all embodiments. The total power of the light emitted from an LED can be measured by using an integrating sphere equipped with spectrometer, for example a SLM12 from Sphere Optics Lab Systems. The desired power depends, in part, on the optical system that the LED is being utilized within.

The light generated by the LED may also have a high total power flux. As used herein, the term “total power flux” refers to the total optical power divided by the light emission area. In some embodiments, the total power flux is greater than 0.03 Watts/mm², greater than 0.05 Watts/mm², greater than 0.1 Watts/mm², or greater than 0.2 Watts/mm². However, it should be understood that the LEDs used in systems and methods presented herein are not limited to the above-described power and power flux values.

In some cases, it may be preferable for at least one of the edges of the light-emitting diode to be relatively large. For example, in certain embodiments, at least one of the edges of a light-emitting diode (e.g., at least one of light-emitting diodes 202, 204, 206, 302, 304, 306, and/or 308, and/or any other LED described herein) is at least about 1 mm, at least about 1.5 mm, at least about 2 mm, at least about 2.5 mm, at least about 3 mm, or at least about 5 mm. In some embodiments, more than one edge (e.g., all edges) of the light-emitting device have the edge lengths noted above. Such dimensions lead to LEDs, and emission surfaces, having large areas. For example, in some cases, the surface area of the emission surface of any of the LEDs described herein may be at least about 1 mm², at least about 2.5 mm², at least about 5 mm², or at least about 10 mm². The techniques described herein may be well-suited for use with large area LEDs. However, it should be understood that the techniques are not limited in this regard.

In certain embodiments, the light-emitting diode can be configured to emit most or all of the light generated by active region 512 through emission surface 522. Such light-emitting diodes are commonly referred to as “top-emitting” (as opposed to “side-emitting”) light-emitting diodes. In certain embodiments, at least about 75%, at least about 90%, at least about 95%, at least about 99%, or substantially all of the light that is emitted by any of the light-emitting diodes described herein is emitted through the emission surface (e.g., a top emission surface such as emission surface 522 in FIG. 5).

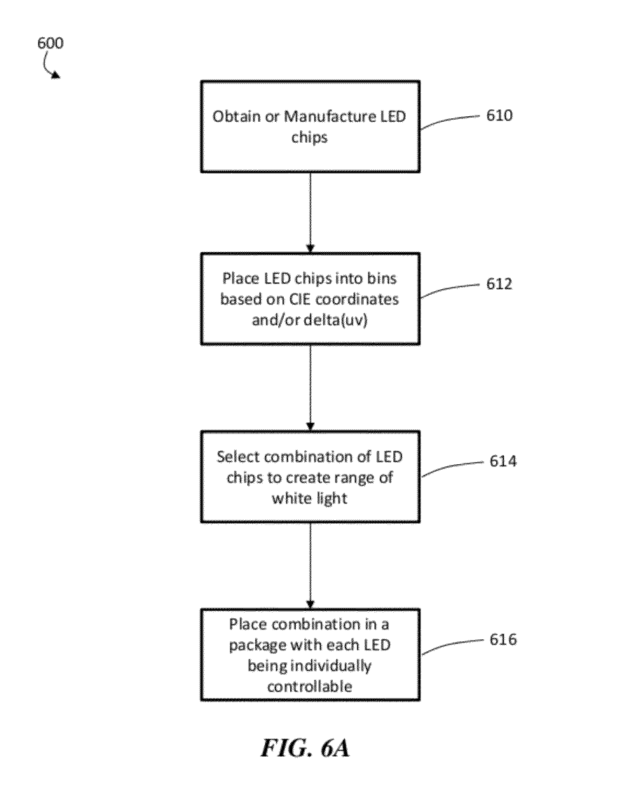

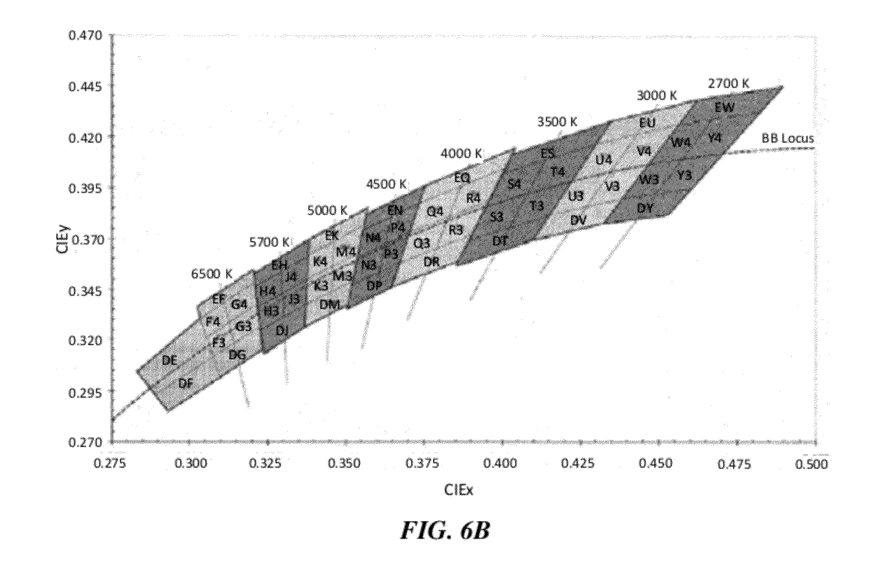

FIG. 6A is a block diagram outlining a method 600 for efficiently utilizing a white LED manufacturing process to produce the LED arrays described herein. First, in step 610, white LED chips are manufactured or obtained from a manufacturing process. The CIE coordinates, correlated color temperatures, and/or Δᵤᵥ values for each chip can be determined using, for example, a spectrophotometer. Next, in step 612, the tested LED chips can be placed into bins according to their CIE coordinates, correlated color temperatures, and/or Δᵤᵥ values. In step 614, a selection of chips from distinct bins can be performed to create a system with a specified range of CIE coordinates, correlated color temperatures, and/or Δᵤᵥ values. For example, in certain embodiments, the system can comprise four LED chips: one that emits light having a cool white temperature that is above the black body locus, one that emits light having a cool white temperature that is below the black body locus, one that emits light having a warm white temperature that is above the black body locus, and one that emits light having a warm white temperature that is below the black body locus.

FIG. 6B is an exemplary CIE 1931 chromaticity plot that has been divided up into several bins, with each bin receiving a particular bin indicator. In certain embodiments, once the LEDs emitting substantially white light have been produced, their light outputs can be measured, and the LEDs can be placed in the bins shown in FIG. 6B, or into a similar sorting system. Subsequently, one can choose from the various quadrants those LEDs that will produce a desired range of white light. It should be noted that, unlike the other chromaticity plots discussed herein (which are generally CIE 1960 chromaticity plots), the chromaticity plot in FIG. 6B is a CIE 1931 chromaticity plot. However, one of ordinary skill in the art would be capable of converting from the x- and y-coordinates of the CIE 1931 chromaticity space to the u- and v-coordinates of the CIE 1960 chromaticity space using Equations [3] and [4], respectively:

$$\begin{matrix}u = \frac{5.5932 x + 1.9116 y}{12 y - 1.882 x + 2.9088} & [ 3 ] \\ v = \frac{7.8972 y}{12 y - 1.882 x + 2.9088} & [ 4 ]\end{matrix}$$

Referring back to FIG. 6A, in step 616, the selected LED chips can be placed into a system that enables independent, individual control of each LED chip. The binning and selection process described in association with FIG. 6A can allow for the production of a relatively low-cost white light-emitting system.

As noted above, the methods and systems described herein are not limited to a specified number of LED chips. In addition, such methods and systems can take advantage of yield distribution when producing white LED chips.

The systems and methods described herein can be used in a variety of lighting applications. For example, as described above, such systems and methods can be used to produce light having a desired position on the CIE 1960 chromaticity diagram for lighting a studio or other environment in which movies or television programs are filmed or recorded. The embodiments described herein may also be useful in environments such as restaurants to be able to tune in a particular ambience that maintains itself in spite of the varying input of natural light into the ambience.

As used herein, when a structure (e.g., layer, region) is referred to as being “on”, “over” “overlying” or “supported by” another structure, it can be directly on the structure, or an intervening structure (e.g., layer, region) also may be present. A structure that is “directly on” or “in contact with” another structure means that no intervening structure is present.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

What is claimed is:

1. A light-emitting system, comprising:
a first light-emitting diode configured to emit substantially white light having a first position on a CIE 1960 chromaticity diagram;
a second light-emitting diode configured to emit substantially white light having a second position on the CIE 1960 chromaticity diagram, wherein the position of the light emitted from the second light-emitting diode is different from the position of the light emitted by the first light-emitting diode; and
a third light-emitting diode configured to emit substantially white light having a third position on the CIE 1960 chromaticity diagram, wherein the position of the light emitted from the third light-emitting diode is different from the position of the light emitted by the first light-emitting diode and different from the position of the light emitted by the second light-emitting diode;
wherein the system is configured such that the intensities of the first, second, and third light-emitting diodes can be adjusted, and the system is configured to produce cumulative emissions of substantially white light at at least three points on a black body locus of the CIE 1960 chromaticity diagram.

2. The light emitting system of claim 1, wherein the second light-emitting diode is configured to emit substantially white light having a third position above the black body locus on the CIE 1960 chromaticity diagram.

3. The light emitting system of claim 1, wherein the third light-emitting diode is configured to emit substantially white light having a third position above the black body locus on the CIE 1960 chromaticity diagram.

4. The light emitting system of claim 1, wherein the first light-emitting diode is configured to emit substantially white light having a first position above the black body locus on the CIE 1960 chromaticity diagram.

5. The light emitting system of claim 1, wherein the first light-emitting diode is configured to emit substantially white light having a first position below the black body locus on the CIE 1960 chromaticity diagram.

6. The light-emitting system of claim 1, further comprising a fourth-light emitting diode configured to emit substantially white light having a fourth position on the CIE 1960 chromaticity diagram that is different from the third position of the light emitted by the third light-emitting diode, different from the second position of the light emitted by the second light-emitting diode, and different from the first position of the light emitted by the first light-emitting diode.

7. The light emitting system of claim 6, wherein the fourth light-emitting diode is configured to emit substantially white light having a fourth position above the black body locus on the CIE 1960 chromaticity diagram.

8. The light emitting system of claim 6, wherein the fourth light-emitting diode is configured to emit substantially white light having a fourth position below the black body locus on the CIE 1960 chromaticity diagram.

9. The light-emitting system of claim 1, wherein the first light-emitting diode is configured to emit substantially white light having a first position with an x-axis value of less than 0.375 on the CIE 1960 chromaticity diagram.

10. The light-emitting system of claim 1, wherein the second light-emitting diode is configured to emit substantially white light having a second position with an x-axis value of less than 0.375 on the CIE 1960 chromaticity diagram.

11. The light-emitting system of claim 1, wherein the first position of the substantially white light from the first light-emitting diode is spaced at least about 0.025 CIE units away from the second position of the substantially white light from the second light-emitting diode on the CIE 1960 chromaticity diagram.

12. The light-emitting system of claim 1, wherein the third light-emitting diode is configured to emit substantially white light having a third position with an x-axis value of greater than 0.375 on the CIE 1960 chromaticity diagram.

13. The light-emitting system of claim 6, wherein the fourth light-emitting diode is configured to emit substantially white light having a fourth position with an x-axis value of greater than 0.375 on the CIE 1960 chromaticity diagram.

14. The light-emitting system of claim 1, wherein at least one of the first, second, and third light-emitting devices are configured to emit substantially white light having a position on the CIE 1960 chromaticity diagram defining a Δᵤᵥ value having an absolute value of less than 0.02.

15. The light-emitting system of claim 1, wherein at least one of the first, second, and third light-emitting devices comprises an edge with a length of at least about 1 mm.

16. The light-emitting system of claim 1, wherein at least one of the first, second, and third light-emitting devices comprises a wavelength-converting material positioned over the emission surface of the light-emitting device.

17. The light-emitting system of claim 16, wherein the wavelength-converting material comprises a phosphor.

18. The light-emitting system of claim 1, wherein at least one of the first, second, and third light-emitting devices is configured such that at least 75% of the light generated by a light-generating region within the light-emitting device is emitted through an emission surface of the light-emitting device.

19. The light-emitting system of claim 1, further comprising a controller configured to adjust the intensity of at least the first light-emitting diode.

20. The light-emitting system of claim 1, wherein the largest nearest neighbor distance between the first light-emitting diode, the second light-emitting diode, and the third light-emitting diode is less than about 1 mm.

21. The light-emitting system of claim 1, wherein the first light-emitting diode, the second light-emitting diode, and the third light-emitting diode form an array.

22. The light-emitting system of claim 1, wherein the system is configured to produce cumulative light outputs along the black body locus with a range that spans at least about 500 Kelvin.

23. A method, comprising:
emitting substantially white light from a first light-emitting diode of a light-emitting system, the substantially white light from the first light-emitting diode having a first position on a CIE 1960 chromaticity diagram;
emitting substantially white light from a second light-emitting diode of the light-emitting system, the substantially white light from the second light-emitting diode having a second position on the CIE 1960 chromaticity diagram;
emitting substantially white light from a third light-emitting diode of the light-emitting system, the substantially white light from the third light-emitting diode having a third position on the CIE 1960 chromaticity diagram; and
adjusting the intensity of light emitted from a first light-emitting diode, independently of the intensity of the light emitted from at least one of the second and third light-emitting diodes.

24. The method of claim 23, comprising adjusting the intensity of light emitted from the first light-emitting diode based at least in part on the wavelength and/or intensity of light in the ambient environment.

25. The method of claim 23, comprising adjusting the intensity of the light emitted from the second light-emitting diode, independently of adjusting the intensity of the light emitted from the first light-emitting diode.

26. The method of claim 25, comprising adjusting the intensity of the light emitted from the third light-emitting diode, independently of adjusting the intensity of the light emitted from the first and second light-emitting diodes.

27. The method of claim 23, comprising mixing the light output by the first light-emitting diode, the second light-emitting diode, and the third light-emitting diode.

28. The method of claim 23, wherein adjusting the intensity of the light emitted from the first light-emitting diode results in a cumulative output of light from the light-emitting system that lies substantially on the black body locus on the CIE 1960 chromaticity diagram.
